(19) United States
(12) Patent Application Publication
(10) Pub. No.: US 2013/0116106 A1
(43) Pub. Date: May 9, 2013

(54) METHOD FOR PRODUCING COLORED GLASS

(71) Applicants: Paul L. F. Servin, Berlin (DE); Philipp Hultsch, Berlin (DE)

(72) Inventors: Paul L. F. Servin, Berlin (DE); Philipp Hultsch, Berlin (DE)

(73) Assignee: NANOPARTICA GMBH, Berlin (DE)

(21) Appl. No.: 13/699,365

(22) PCT Filed: May 26, 2011
(86) PCT No.: PCT/EP11/58694

§ 371 Date: Jan. 24, 2013

(30) Foreign Application Priority Data
May 26, 2010 (DE) 10 2010 021 492.2

(51) Int. Cl. C03C 21/00; C03C 4/02

(52) U.S. Cl. CPC C03C 21/008; C03C 4/02; Y10S 977/779; Y10S 977/89; B82Y 40/00
USPC 501/32; 977/779; 977/890

(57) ABSTRACT

The invention relates to a method for producing colored glass 1, in which at least one powdery and/or sandy raw glass material is melted. The invention further relates to glass 1 produced according to said method. According to the invention, finished nanoparticles 2 made of at least one metal are mixed with the raw glass material and subsequently the mixture is melted together. The glass 1 according to the invention comprises nanoparticles 2 made of at least one metal and exhibits a dichroism that is dependent on whether light is reflected or transmitted by the glass 1. The glass 1 according to the invention is thus colored and changes its color depending on whether visible light is reflected or transmitted.

The invention relates to a method for producing colored glass, in which at least one powdery and/or sandy raw glass material is melted. The invention further comprises glass produced by this method.

Glass is an amorphous, non-crystalline solid, which are characterized in particular by its optical transparency and its substantial resistance to chemicals. The optical properties of various glasses are diverse and be divided in, on the one hand clear glass, which can be distinguished by being transparent in a wide range of different wavelength of light, and on the other hand, glass whose permeability is decreased or blocked by the addition of certain substances. The most commonly used control of permeability is via coloring, wherein the different colors can be produced. Moreover there is impermeable glass, which due to its composition or addition of opacifier is opaque.

Glass is arranged in a network according to atomic blocks, the network is established by so-called network formers. The most important network former is silizium oxide (SiO₂), which is the main component in many glasses such as quartz glass, soda-lime glass or borosilicate glass. Further network formers are, for instance, boric oxide (B₂O₃) or aluminium oxide (Al₂O₃). Moreover glass can also contain so-called network modifiers and/or stabilizers. Network modifiers are incorporated into the established network by the network formers and are thereby partially tearing the network structure. Commonly used network modifiers are as example sodium oxide (Na₂O), potassium oxide (K₂O), magnesium oxide (MgO) and calcium oxide (CaO).

Glass is commonly produced by melting the glass raw materials together and then the glass melt is cooled down. During the cooling, the viscosity of the glass melt increases, wherein the transition from the melt to the solid network is progressing. Since the transformation from the melt to the solidified glass is not spontaneous, the formation of the internal structure of glass is commonly called a transition phase. In the cooled end of transition phase, the so called glass transition is when the melt is turned into a glassy, solid state. The amorphous, viscose state of the glass transition is used by the glass manufacturers for the formation of glass.

In glassmaking the glass raw materials are mixed together. Examples of glass raw materials being used are quartz sand, sodium carbonate, potash, feldspar, limestone, dolomite and/or recycled glass. The glass raw material mixture is melted at approx.: 1400° C. and then further refined. During the refining of the melted glass the gas bubbles are being expelled. The glass melt is cooled by a controlled temperature reduction in which the tensions of annealing, viz. the defined slow cooling in a cooling region, can be reduced. The cooling region is a specific temperature interval, which is different for each glass, ranging between an upper and lower cooling temperature. The cooling region is usually between 590° C. and 450° C.

After the decay of the Roman empire some knowledge concerning glass manufacturing and processing was lost. Glass, especially colored glass, had a renaissance in the 14^{th} century in Venice. Here the recipes for glass coloration were kept secret from generation to generation of glassmakers. For this reason, many of these staining techniques were lost again and had to or have to be re-discovered. Generally colored glass is produced through the addition of a stain to a basic glass melt. It is however also possible to stain colorless glass by tinting only the surface at 400-600° C. which gives a non stained through glass. Surface staining is commonly made by means of silver tinting, yielding a yellow to red-brown glass.

For the production of fully stained through glass, two different methods are being used. With the metal oxide coloration (coloring by ions) especially metals such as iron, copper, chromium, cobalt and nickel are being added as coloring additives. The color of the glass becomes based on the color of the metal ion in its current environment. The dissolved metal ions solidify after the melting of the glass raw materials, so that the glass is clear and no longer appears to give spectral changes. Annealing or coloring through tempering is especially used for cadmium salts, even better, cadmium mixed salts and metal colloids from metals such as copper, silver and gold. These colloids give an intensive yellow, orange or red color of glass with the subsequent heat treatment and controlled cooling (annealing).

For example a known method for producing ruby red glass is to mix gold salt with a glass raw material melt (Wagner et al., Nature, 2000, 407, 691). The gold salt is dispersed into the glass raw material melt at 1400° C., and upon rapid cooling down to room temperature the glass is clear. The glass is then annealed for 10-17 hours at 500-700° C. upon which the red color appears due to the formation of small gold particles.

An especially famous example of glass coloring with gold is the so called Lycurgus-cup, which is exhibited in the British museum in London. This cage cup is dated to the 4^{th} century A.D. and is particularly distinguished for its dichroism. In reflected light the cage cup appears to be opaque green, while it by transmitted light appears light red. It has been found that this color effect comes from the special mixture of colloidal gold and silver. The glass coloring with metal nanoparticles does not only have an aesthetically pleasing effect but may also have specific technical meaning. One can see applications of the metal nanoparticles in glass within optics, electronics as well as solar cells. As an example within optics the resolution can be significantly improved since the metal nanoparticles influences the wavelength of the light. With solar cells the conversion of light to electrical energy improved and in the electronics it will be possible to develop optical components since the plasmonic effect of metal nanoparticles promotes the development of very fast switches and modulators with response times in the range of pico seconds. The plasmonic effect appears when beaming light encounters a metal nanoparticle, upon which the oscillating electrical field of the light is influencing the conducting electrons on the metal and through this a dipole moment is created. Through the re-distribution of the charges the shifted electrons establishes a counter-movement, which causes a corresponding resonance frequency (Murray et al., Adv. Mater., 2007, 19, 3771). To receive the plasmonic effect, the size of the metal nanoparticles must be small in comparison to the wavelength of the light. In practice until yet, the plasmonic effect has been achieved by having metal nanoparticles on the surface of the glass, this has been achieved by adding dissolved salts of metal ions and then reducing them to metal nanoparticles.

For example, a method for coloring glass is known from DE-A-10 053 450, wherein the powder starting material is mixed, melted and refined. After the cooling of the glass it is shaped according to wish in forms. To develop the color of the resulting blank the glass is annealed respectively tempered. Here the coloring agent is mounted on one or more of the powdered raw material, wherein the coloring agent is dissolved and can be sprayed on the powder raw material and then dried. In this fashion a coated base material is created. The actual coloring agents used are salts or preferably oxides that are added or mixed into the starting material. The in this fashion raw material containing coloring agent is reduced to give the real color which comes from metallic colloids, this is done by adding one or several reductive organic hydrocarbon compounds to the starting material. Alternatively also metallic reduction agents such as silizium, aluminium, zink and also other metals, their oxides are used not only for the production of glass but also glass-ceramic. This well known process has however one disadvantage which is that it is tedious and therefore has a high energy demand and a long process time.

Furthermore, from EP-A-0 675 084 a process for preparing crimson decors is known, in which a gold compound and a finely divided glass flux containing agent is built up to the substrate to be decorated and that is then burned at a temperature between 400 and 1050° C. These finely divided glass flux used are so called glass frits, a glass, which were quenched after melting and milled, it can be transparent or opaque, colorless or even oxide colored glass frits. In this process either organic or inorganic gold compounds are used, which are completely decomposed into colloidal gold in the presence of the divided glass flux while heating-up to the burning temperature. For the preparation of this decor thus no crimson pigment is added, but it is being produced in situ from suitable raw materials, namely a glass flux and a decomposable gold compound. Through this method one can dispense a separately production of pigments. With selection of the used gold compounds as well as the glass flux with a certain gold concentration it is possible to create different shades of crimson in the decor. Still, this commonly known method is tedious and has high energy demands as well as long process time.

It is the object of this invention to provide a method for producing dichroic glass which can be accomplished easier and faster with less energy demand in comparison to classical glass coloring methods while maintaining the desired optical effects.

According to the invention the object is achieved by mixing finished nanoparticles made of at least one metal with raw glass material before melting and subsequently melting this mixture together. Due to the fact that the metal nanoparticles are produced before the addition to the raw glass material, the method according to the invention is easier than conventional coloring techniques. Besides from this the desired optical properties can easily be controlled, since the size and shape of the nanoparticles is much better controlled when they are separately produced. For the plasmonic effect the size, the shape as well as the distance between the nanoparticles is of importance. Moreover, through the mixture of the already produced nanoparticles in defined size and/or shape with the raw glass material before melting, the previously mentioned parameters can be optimally adjusted, so that the glass according to the invention, produced by the method of the invention, exhibits the desired properties. The diameter of the nanoparticles in the finished glass can be size influenced, for example, by the selection of the final nanoparticles resp. their size which are then mixed with the raw glass material and which are rounded off in the melting process into a spherical shape. As an example the color of the glass in this innovative production method can be controlled by the size of the finished nanoparticles. Further on in this innovative process the size of the nanoparticles in the glass can be controlled through the adjusted temperature, the time of the cooling (tempering) and/or the size of the glass particles (with the usage of recycled glass as raw material). An additional advantage in the method of the invention is that the nanoparticles, through the innovative production process, also are distributed in the surface layer of the produced glass, so that the glass can also be used for solar cells. An essential advantage of the invention lies in that via the joint melting of the nanoparticles as well as the raw glass material one can exclude the color annealing, which significantly decreases the color process and results in a significant energy saving.

In an advantageous embodiment of the inventive method it is provided that the nanoparticles are admixed to the raw glass material at a concentration of 0.001% by weight to 0.20% by weight, preferably 0.005% by weight to 0.10% by weight, particularly preferably from 0.01% by weight to 0.06% by weight.

In a further advantageous embodiment of the inventive method it is provided that the nanoparticles comprises at least one metal, preferably a metal of groups 8 to 12 of the periodic table of elements. Herein nanoparticles that consist of only one metal or compositions of nanoparticles made of different metals may be used.

Preferably, the nanoparticles comprise gold, silver, copper, platinum and/or nickel. Basically, however, all color forming metals can be used in this innovative process.

The glass raw material can for instance comprise glass sand, preferably quartz sand, and/or crushed glass. While quartz glass contains 100% of SiO₂, for instance, soda-lime glass contains besides from SiO₂ also Al₂O₃, Na₂O and CaO. Lead crystal glass contains, for instance, SiO₂, Na₂O, K₂O, B₂O₃ and PbO. Since with this innovative method it is possible to stain all types of glass, the glass raw material resp. the glass raw materials can be selected accordingly.

In an advantageous embodiment of the inventive method it is provided that the mixture can be melted at a temperature of 400° C. to 1400° C., preferably 400° C. to 1200° C., particularly preferably 500° C. to 1100° C., in particular 600° C. to 1000° C.

According to the invention the mixture can be melted for a duration of 3 to 40 hours. But in a particular advantageous embodiment of the inventive method it is provided that the mixture is preferably melted over for a duration of 3 to 10 hours, more preferably 4 to 7 hours. The inventive method allows a very short processing time, without that the color formation and the formation of the desired optical effect is adversely affected.

The invention further comprises glass comprising nanoparticles made of at least one metal and exhibiting a dichroism which is dependent on whether the light is reflected or transmitted by the glass, wherein the glass is produced according to the method of the invention. Thus, the glass according to the invention is colored and changes its color depending on whether the visible light is reflected or transmitted. This effect is very similar to that of the Lycurgus-cup.

The nanoparticles are homogeneously distributed in the glass according to the invention, including the surface thereof, which makes the glass especially interesting for the manufacture of solar cells.

In a particular advantageous embodiment of the inventive method it is provided that the nanoparticles are formed at least approximately spherical. Since the nanoparticles are melted in the innovative process together with the glass material, they are rounded up during the melting process to spheres.

In another particular advantageous embodiment of the inventive method it is furthermore provided that the nanoparticles have a diameter of at least 20 nm, preferably at least 30 nm, more preferably at least 40 nm. The special properties of the glass according to the invention occur in particular with the appearance of larger particles, especially particles with a diameter of about 50 nm. From a particle size above 150 nm, there is no longer a plasmonic effect. Preferred ranges for the diameter of the nanoparticles in the glass are thus 20 to 150 nm, 30 to 150 nm, 40 to 150 nm and in particular 50 to 150 nm.

The invention is further illustrated in detail by the following figures.

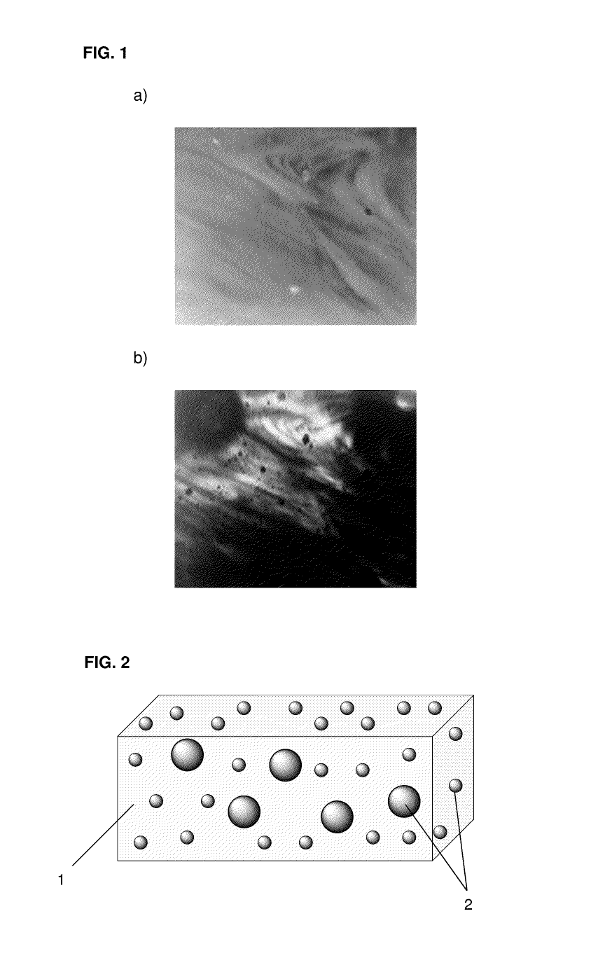

FIG. 1 shows two photographic images of a glass that has been colored by the method according to the invention, a) reflected light, b) transmitted light. FIG. 1 shows the different optical effects which can be generated by a coloring according to the method of the invention. This points out clearly that the color of the glass is changed depending on whether the glass is seen in reflected light (a) or in transmitted light (b). This effect is similar to that of the famous Lycurgus-cup, so that the novel process in a simple and energy-saving way enables the manufacture of aesthetic glass.

FIG. 2 shows a schematic representation of the distribution of the metal nanoparticles in a glass produced by the method according to the invention, which was prepared according to the invented method. Since the nanoparticles (2) were melted together with the glass raw material, they are spherical. Here it becomes clear that the nanoparticles (2) are evenly distributed in the glass, wherein the nanoparticles (2) are also present on the surface of the glass (1). This has the advantage that the glass produced by the method according to the invention also will be suitable for solar cell manufacture.

### EXAMPLES

### Example 1

Gold and silver nanoparticles were added in different concentrations to 2 g of crushed glass (see Table 1). The individual samples were then melted at 600° C. for 7 hours.

Depending on the chosen concentration different colors were produced in the glass, ranging from pale pink (A1) to yellow (B3) to orange/green (D3).

TABLE 1
Glass staining with different gold and/or
silver nanoparticle concentrations.

| | A | B | C | D |
|---|---|---|---|---|
| 1 | Au 0.005% | Au 0.010% | Au 0.015% | Au 0.020% |
| | w/w | w/w | w/w | w/w |
| | Ag 0.005% | Ag 0.010% | Ag 0.015% | Ag 0.020% |
| | w/w | w/w | w/w | w/w |
| 2 | Au 0.005% | Au 0.010% | Au 0.015% | Au 0.020% |
| | w/w | w/w | w/w | w/w |
| | Ag 0.010% | Ag 0.020% | Ag 0.030% | Ag 0.040% |
| | w/w | w/w | w/w | w/w |
| 3 | Au 0.005% | Au 0.010% | Au 0.015% | Au 0.020% |
| | w/w | w/w | w/w | w/w |
| | Ag 0.020% | Ag 0.040% | Ag 0.060% | Ag 0.080% |
| | w/w | w/w | w/w | w/w |

### Example 2

To 42 g of crushed glass 0.020% by weight of gold nanoparticles were added. The mixture was divided into three samples. The first sample was put in the oven at 600° C. for 7 hours giving a glass with a deep violet color. The second sample was placed in the oven at 900° C. for 7 hours giving a glass with a red/brown color. The third sample was treated in the oven at 1000° C. for 7 hours giving a glass with a bright red/brown color. In transmission the samples appeared with an increasingly lighter blue.

### Example 3

Already solidified and melted glass having a concentration of 0.04% by weight of gold nanoparticles (1) was crushed and was mixed with glass sand 1:1 (2). The mixture was then melted in an oven for 6 hours at 1000° C. At the higher concentration of nanoparticles (1) resulted in an opaque reflection red/brown in color, while the glass with the lower concentration (2) showed an opaque light red color. For transmission showed (1) a deep blue violet and (2) a blue color.

### Example 4

0.04% by weight of gold nanoparticles and 0.09% by weight of silver nanoparticles (1) and accordingly 0.04% by weight of gold nanoparticles and 0.04% by weight of silver nanoparticles (2) in solvent were added to crushed glass material, the solvent has been removed and the mixture was melted in a muffle furnace for 6 hours at 1000° C. In mixture (1) the glass has in reflection an opaque olive green color, the glass in mixture (2) also had an opaque olive green color. The transmission color was not observed in (1) due to the high concentration and in (2) there was a deep purple color.

### Example 5

0.015% by weight of gold nanoparticles and 0.035% by weight of silver nanoparticles were added to 30 g of crushed glass. The mixture was melted in a muffle furnace at 1000° C. After 2 hours, a small sample was taken. Due to the presence of gas bubbles was only a green color in reflected light observed, but no staining in transmitted light. After 4 hours an additional sample was taken. The gas bubbles were now almost gone and it is essentially a green color shown in reflected light and a pink coloration in transmitted light. The experiment was terminated after 6 hours. Then the resulting glass had a green-brown color in reflected light, and a pink/blue color in the transmitted light.

### Example 6

0.04% by weight of nickel nanoparticles in a solvent was added to 10 g of crushed glass. The solvent was removed and the mixture was melted in an oven for 6 hours at 1000° C. The resulting glass was a light yellow coloration.

### Example 7

0.04% by weight of copper nanoparticles in a solvent was added to 10 g of crushed glass. The solvent was removed and the mixture was melted in an oven for 6 hours at 1000° C. The resulting glass was a light blue color.

### Example 8

0.04% by weight of silver nanoparticles in a solvent was added to 10 g of crushed glass. The solvent was removed and the mixture was melted in an oven for 6 hours at 1000° C. The resulting glass did not show staining, however the glass shone and glittered much more than normal glass, so that it can be for instance used in solar cells due to the dispersed silver nanoparticles.

### Example 9

To a stirred and boiled 350 mL of an aqueous HAuCl₄×3 H₂O (2.5×10⁻⁴ M) solution was added 11 mL of a 1% aqueous sodium citrate solution. The solution gradually changed color until finally a wine-red color appeared. The solution was then boiled for an additional 30 minutes before 50 g of crushed glass was added and the water was evaporated. The mixture was melted for 7 hours at 1100° C. The received glass was wine-red in reflected light and blue in transmitted light.

The metal nanoparticles used for carrying out the method according to the invention can be produced by methods known to a person skilled in the art. The known methods for preparing nanoparticles include, for example, abrasion, pyrolysis, plasma, sol gel and other methods which involve the reduction of the metal ions. The metal nanoparticles can be stabilized by organic molecules (NR Jana: Chem. Mater., 2001, 13, 2313). Preferred according to the invention are methods that allow the production of nanoparticles with approximately defined and evenly distributed size.

1. A method for producing colored glass, comprising melting at least one powdery and/or sandy raw glass material, mixing finished nanoparticles comprising at least one metal are with the raw glass material to produce a mixture before melting, and subsequently melting the mixture together.

2. The method according to claim 1, wherein the nanoparticles are admixed to the raw glass material at a concentration of 0.001% by weight to 0.20% by weight.

3. The method according to claim 1, wherein the nanoparticles consist of at least one metal.

4. The method according to claim 3, wherein the nanoparticles consist of gold, silver, copper, platinum and/or nickel.

5. The method according to claim 1, wherein the raw glass material comprises glass sand and/or crushed glass.

6. The method according to claim 1, wherein the mixture is melted at a temperature from 400° C. to 1400° C.

7. The method according to claim 1, wherein the mixture is melted for a duration of 3 to 40 hours.

8. A glass comprising nanoparticles made of at least one metal and exhibiting dichroism depending on whether the light is reflected or transmitted by the glass, wherein the glass was produced according to the method of claim 1.

9. The glass according to claim 8, wherein the nanoparticles are homogeneously distributed in the glass, including the surface thereof.

10. The glass according to claim 8, wherein the nanoparticles (2) are formed at least approximately spherical.

11. he glass according to claim 8, wherein the nanoparticles have a diameter of at least 20 nm, preferably at least 30 nm, more preferably at least 40 nm.

12. The method according to claim 2, wherein the nanoparticles are admixed to the raw glass material at a concentration of 0.005% by weight to 0.10% by weight.

13. The method according to claim 2, wherein the nanoparticles are admixed to the raw glass material at a concentration of 0.01% by weight to 0.06% by weight.

14. The method according to claim 3, wherein the at least one metal is a metal of groups 8 to 12 of the periodic table.

15. The method according to claim 5, wherein the glass sand is quartz sand.

16. The method according to claim 6, wherein the mixture is melted at a temperature from 400° C. to 1200° C.

17. The method according to claim 16, wherein the mixture is melted at a temperature from 500° C. to 1100° C.

18. The method according to claim 17, wherein the mixture is melted at a temperature from 600° C. to 1000° C.

19. The method according to claim 7, wherein the mixture is melted for a duration of 3 to 10 hours.

20. The method according to claim 19, wherein the mixture is melted for a duration of 4 to 7 hours.
